(19) United States
(12) Patent Application Publication
(10) Pub. No.: US 2018/0162274 A1
(43) Pub. Date: Jun. 14, 2018

(54) VEHICLE SIDE-REAR WARNING DEVICE AND METHOD USING THE SAME

(71) Applicant: KYUNG CHANG INDUSTRIAL CO., Ltd., Daegu (KR)

(72) Inventors: Jung Hyun Kim, Gyeongsangbuk-do (KR); Tae Hun Park, Daegu (KR); Manjin Kim, Daegu (KR)

(21) Appl. No.: 15/379,970

(22) Filed: Dec. 15, 2016

(30) Foreign Application Priority Data
Dec. 8, 2016 (KR) 1020160166534

(51) Int. Cl. B60Q 9/00; B60R 1/00; G06K 9/00

(52) U.S. Cl. CPC B60Q 9/008; B60R 1/00; B60R 2300/8093; B60R 2300/105; G06K 9/00791

(57) ABSTRACT

A vehicle side-rear warning device includes a camera which records a side-rear of a vehicle, a sensor, a monitor which displays an image recorded by the camera, and a side-rear warning system control unit. An image signal recorded by the camera and a signal sensed by the sensor are input to the side-rear warning system control unit, which determines whether an object is located at a predetermined area of the side-rear of the vehicle based on the input image signal and the input signal sensed by the sensor. When the object is located within a predetermined area of the side-rear of the vehicle, the side-rear warning system control unit outputs a warning signal. The monitor displays the image signal received from the side-rear warning system control unit.

### CROSS REFERENCE TO RELATED APPLICATIONS

Priority is claimed under 35 U.S.C. § 119 to Korean Patent Application No. 10-2016-0166534, filed Dec. 8, 2016, the disclosure of which is incorporated by reference in its entirety.

### BACKGROUND

### Field

The present disclosure relates to a device which senses an object located on the side-rear of a vehicle and warns the driver of the vehicle, and relates to a warning method using the same. More particularly, the present disclosure relates to a device which determines whether or not an object is located at a predetermined area of the side-rear of the vehicle by using a camera or a sensor and then warns the driver of the vehicle, and relates to a warning method using the same.

### Description of the Related Art

A camera, a radar, a lidar, an infrared sensor, etc., are used to recognize the ambient conditions of a vehicle. The sensor is used in a system that recognizes a risk of collision of the vehicle and prevents a traffic accident by generating a warning sound. Also, a radar, an ultrasonic sensor, etc., are used in a system that detects the position and speed of other vehicles traveling on the side-rear of the vehicle and warns a driver. Additionally, they are also used in a system that determines what an object in front of the vehicle is, how far the object is away from the vehicle, etc., and assists the driver's driving.

The above conventional technology has been functioning as an assist device which detects a vehicle in front of or behind a traveling vehicle, pedestrians, obstacles, etc., and assists the driver's driving. In a modern vehicle technology, a driver's driving assistance system is increasing and the weight of the vehicle is reducing. In accordance with the trend of being equipped with electric and electronic parts and of becoming lighter, there is a requirement for growing the driving assistance function and for relatively reducing the weight of the vehicle.

### SUMMARY

One embodiment is a vehicle side-rear warning device that includes: a camera which records a side-rear of a vehicle; a sensor; a monitor which displays an image recorded by the camera; and a side-rear warning system control unit. An image signal recorded by the camera and a signal sensed by the sensor are input to the side-rear warning system control unit. The side-rear warning system control unit determines whether an object is located at a predetermined area of the side-rear of the vehicle or not on the basis of the input image signal and the input signal sensed by the sensor. When it is determined that the object is located at a predetermined area of the side-rear of the vehicle, the side-rear warning system control unit outputs a warning signal, and when it is determined that the object is not located at a predetermined area of the side-rear of the vehicle, the side-rear warning system control unit does not output the warning signal. The monitor displays the image signal received from the side-rear warning system control unit.

Another embodiment is a warning method of the side-rear warning device of a vehicle. The warning method includes: extracting a detection target of an object from a side-rear image of the vehicle recorded by a camera disposed on the vehicle; calculating a distance between the vehicle and the object from a signal sensed by a sensor disposed on the vehicle; determining that a threat level of the object is a first threat level when the size of pixels included in the detection target is equal to or larger than a first set value and the calculated distance is equal to or less than a first distance value; displaying, when it is not determined that the threat level of the object is the first threat level, the recorded image on a monitor disposed in the vehicle without outputting a warning signal; determining that the threat level of the object is a second threat level when it is determined that the threat level of the object is the first threat level and when the size of pixels included in the detection target is equal to or larger than a second set value larger than the first set value and the calculated distance is equal to or less than a second distance value less than the first distance value; displaying the recorded image on the monitor and outputting a first warning signal, when it is not determined that the threat level of the object is the second threat level; and displaying the recorded image on the monitor and outputting a second warning signal, when it is determined that the threat level of the object is the second threat level.

Further another embodiment is a warning method of the side-rear warning device of a vehicle. The warning method includes: extracting a detection target of an object from a side-rear image of the vehicle recorded by a camera disposed on the vehicle; calculating a distance between the vehicle and the object from a signal sensed by a sensor disposed on the vehicle; determining that a threat level of the object is a first threat level when the size of pixels included in the detection target is equal to or larger than a first set value or the calculated distance is equal to or less than a first distance value; displaying, when it is not determined that the threat level of the object is the first threat level, the recorded image on a monitor disposed in the vehicle without outputting a warning signal; determining that the threat level of the object is a second threat level when it is determined that the threat level of the object is the first threat level and when the size of pixels included in the detection target is equal to or larger than a second set value larger than the first set value or the calculated distance is equal to or less than a second distance value less than the first distance value; displaying the recorded image on the monitor and outputting a first warning signal, when it is not determined that the threat level of the object is the second threat level; and displaying the recorded image on the monitor and outputting a second warning signal, when it is determined that the threat level of the object is the second threat level.

### BRIEF DESCRIPTION OF THE DRAWINGS

FIGS. 1 and 2 are block diagrams showing a configuration of a vehicle side-rear warning device according to an embodiment of the present invention;

FIG. 3 is a view showing the vehicle side-rear warning device according to the embodiment of the present invention;

FIG. 4 is a block diagram showing an image handling and threat detection module of the vehicle side-rear warning device according to the embodiment of the present invention;

FIGS. 5a to 5e are views showing a camera included in the vehicle side-rear warning device according to the embodiment of the present invention;

FIGS. 6a to 6c are views showing a monitor included in the vehicle side-rear warning device according to the embodiment of the present invention;

FIGS. 7a and 7b are views showing the display type of the monitor included in the vehicle side-rear warning device according to the embodiment of the present invention;

FIG. 8 is a view showing a sensor included in the vehicle side-rear warning device according to the embodiment of the present invention;

FIG. 9 is a view for describing that the threat detection module according to the embodiment of the present invention determines whether an object included in an image is a threat factor or not;

FIGS. 10a and 10b are views showing that a warning signal and an image are displayed on the monitor according to the embodiment of the present invention;

FIGS. 11a to 11d are views for describing a method for detecting the object included in the image recorded by the camera according to the embodiment of the present invention;

FIGS. 12a and 12b are views for describing whether the object in the image recorded by the camera according to the embodiment of the present invention is a threat factor or not in accordance with the size of a detection target; and

FIGS. 13a and 13b are flowcharts for describing a warning method of the vehicle side-rear warning device according to the embodiment of the present invention.

### DETAILED DESCRIPTION

The objects, particular advantages and novel features of the present invention will be more apparent from the following descriptions and exemplary embodiments which are related to the accompanying drawings. In the drawings, the same or similar elements are denoted by the same reference numerals even though they are depicted in different drawings. While terms such as the first and the second, etc., can be used to describe various components, the components are not limited by the terms mentioned above. The terms are used only for distinguishing between one component and other components. Throughout the description of the present invention, the detailed description of known technologies incorporated herein will be omitted when it may make the subject matter of the present invention unclear.

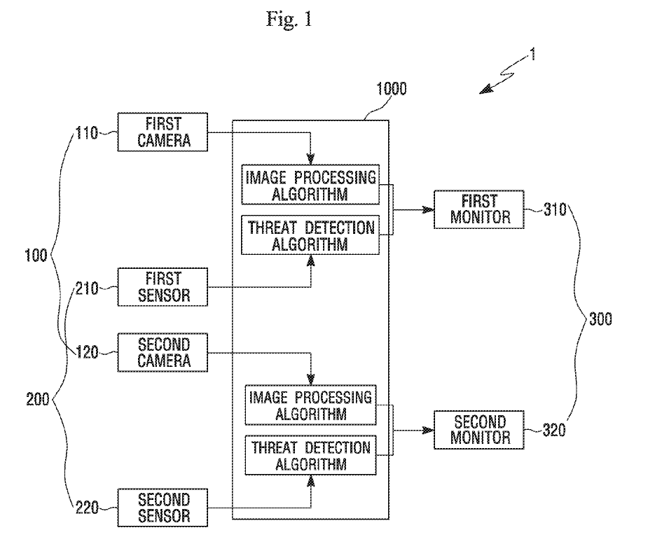

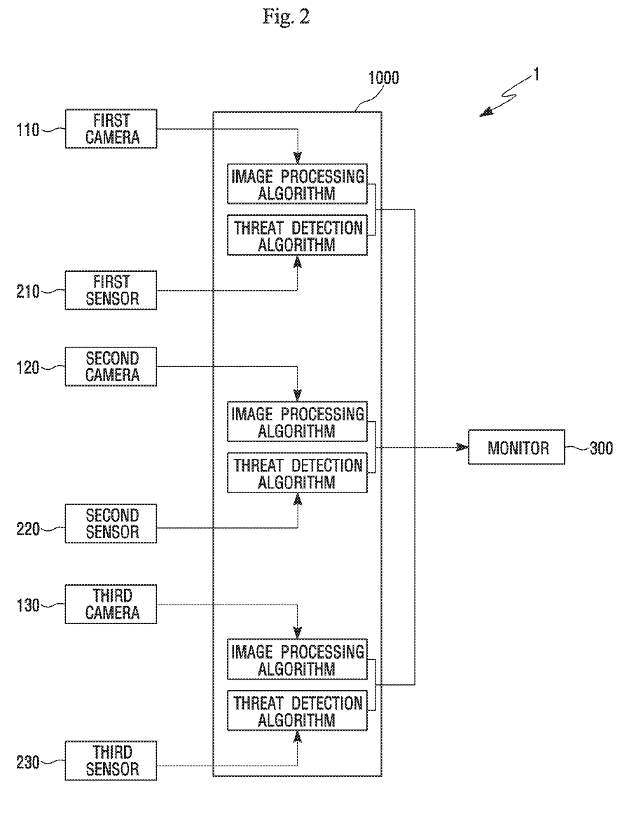

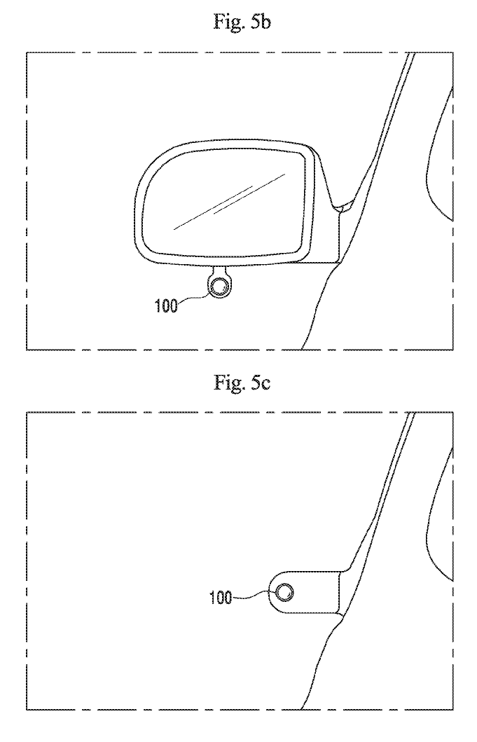

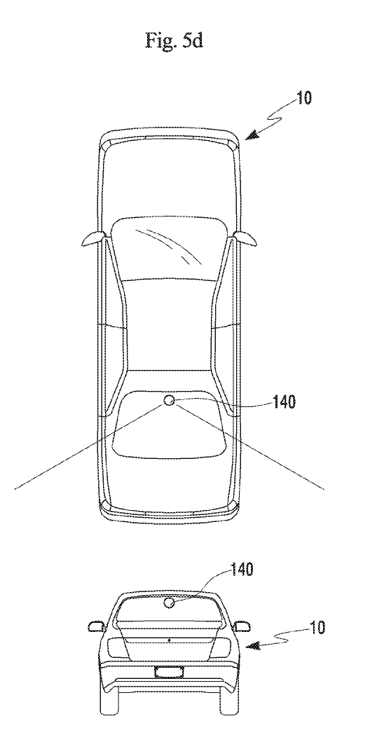

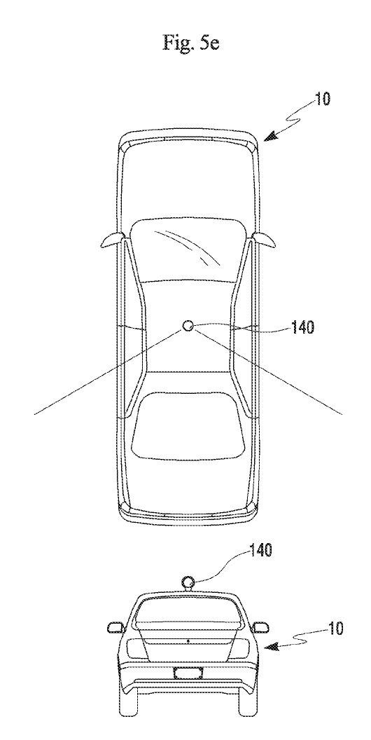

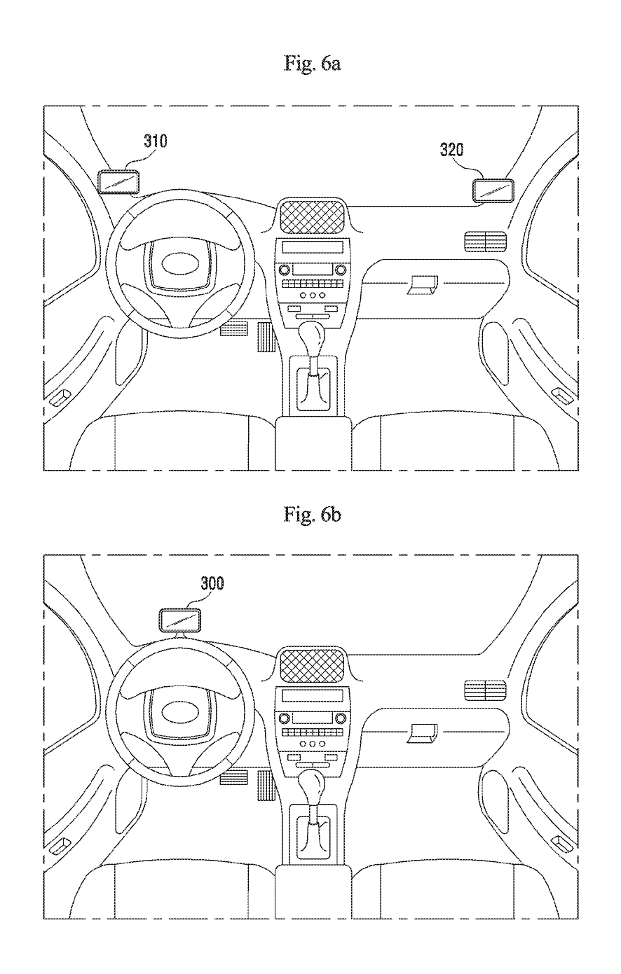

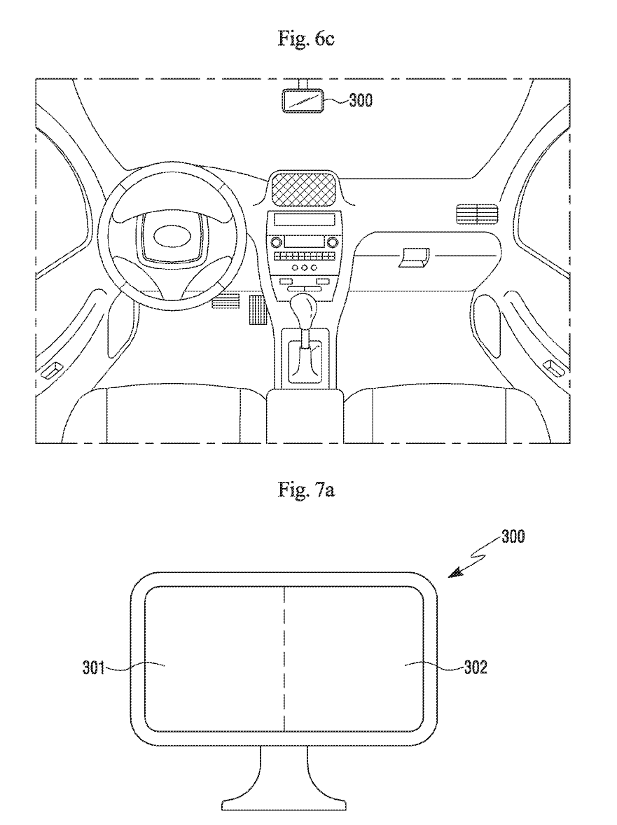

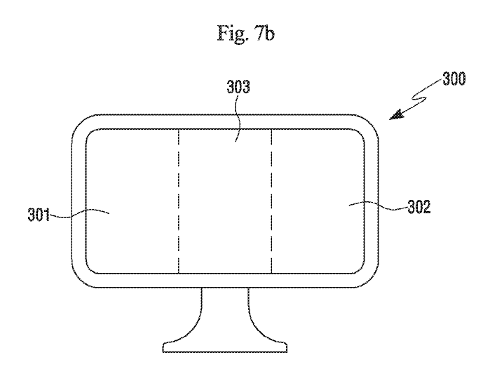

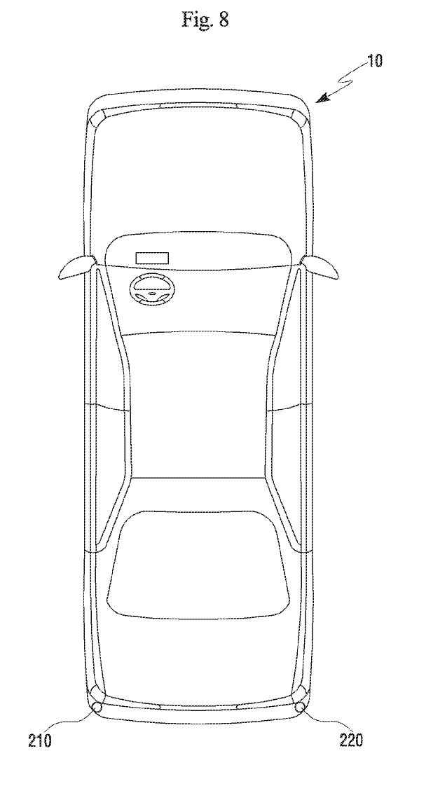

The embodiment of the present invention will be described in detail with reference to the accompanying drawings. FIGS. 1 and 2 are block diagrams showing a configuration of a vehicle side-rear warning device according to an embodiment of the present invention. FIGS. 5a to 5e are views showing a camera included in the vehicle side-rear warning device according to the embodiment of the present invention. FIGS. 6a to 6c are views showing a monitor included in the vehicle side-rear warning device according to the embodiment of the present invention. FIGS. 7a and 7b are views showing the display type of the monitor included in the vehicle side-rear warning device according to the embodiment of the present invention. FIG. 8 is a view showing a sensor included in the vehicle side-rear warning device according to the embodiment of the present invention.

As shown in FIGS. 1 and 2, the vehicle side-rear warning device 1 according to the embodiment of the present invention may include a camera 100, a sensor 200, a side-rear warning system control unit 1000, and a monitor 300. The camera 100 may record the side-rear of the vehicle. The sensor 200 may sense a distance between the vehicle and an object located on the side-rear of the vehicle. The monitor 300 may display a side-rear image of the vehicle recorded by the camera 100. Here, an image signal recorded by the camera 100 and a signal sensed by the sensor 200 may be input to the side-rear warning system control unit 1000. The side-rear warning system control unit 1000 may process the image signal received from the camera 100 by using an image processing algorithm and may determine whether or not the object is located at a predetermined area of the side-rear of the vehicle, through a threat detection algorithm on the basis of both the image signal received from the camera 100 and the signal received from the sensor. Specifically, when it is determined that the object is located at a predetermined area of the side-rear of the vehicle, the side-rear warning system control unit 1000 may output a warning signal. Here, the warning signal may include a visual warning signal, an auditory warning signal, and/or a tactile warning signal. Also, when it is determined that the object is not located at a predetermined area of the side-rear of the vehicle, the side-rear warning system control unit 1000 may not output the warning signal.

As shown in FIGS. 5a to 5c, the camera 100 according to the embodiment of the present invention may be disposed on a side-view mirror of the vehicle. Specifically, as shown in FIG. 5a, the camera 100 may be formed integrally with the side-view mirror. Also, as shown in FIG. 5b, the camera 100 may be formed separately from the side-view mirror and disposed on one side of the side-view mirror. Also, as shown in FIG. 5c, the side-view mirror may include only the camera 100 without the mirror.

As shown in FIG. 8, the sensor 200 according to the embodiment of the present invention may be disposed on the side-rear surface of the vehicle. Specifically, the sensor 200 may include an ultrasonic sensor, a radar, a lidar, an infrared sensor. Specifically, when the sensor 200 is an ultrasonic sensor, an ultrasonic wave launched from the ultrasonic sensor hits an object and is reflected, and then the ultrasonic sensor receives the reflected ultrasonic wave. Then, the ultrasonic sensor measures a time period from when the ultrasonic wave is launched to when the ultrasonic wave is received, thereby measuring a distance between the object and the ultrasonic sensor. Also, as in the case of the ultrasonic sensor, when the sensor 200 is a radar, an electromagnetic wave launched from the radar is reflected, and then the radar receives the reflected electromagnetic wave. Then, the radar measures a time period from when the electromagnetic wave is launched to when the electromagnetic wave is received, thereby measuring a distance between the object and the radar.

As shown in FIGS. 6a to 6c, the monitor 300 according to the embodiment of the present invention is disposed on a position for a driver to check the monitor 300. The monitor 300 may display the side-rear image of the vehicle recorded by the camera 100.

Specifically, as shown in FIG. 1, the camera 100 may include a first camera 110 and a second camera 120. The sensor 200 may include a first sensor 210 and a second sensor 220. The monitor 300 may include a first monitor 310 and a second monitor 320. Here, the first camera 110 may be disposed on a left side-view mirror of the vehicle and may record the left side-rear of the vehicle. The second camera 120 may be disposed on a right side-view mirror of the vehicle and may record the right side-rear of the vehicle.

As shown in FIG. 8, the first sensor 210 may be disposed on the left of the rear of the vehicle 10 and may sense a distance between the vehicle and the object located on the left of the side-rear of the vehicle. The second sensor 220 may be disposed on the right of the rear of the vehicle 10 and may sense a distance between the vehicle and the object located on the right of the side-rear of the vehicle. FIG. 8 describes that the first sensor 210 and the second sensor 220 are disposed on the rear of the vehicle 10. However, the embodiment of the present invention is no limit to this. The first sensor 210, like the first camera 110, may be disposed on the left side-view mirror or may be disposed adjacent to the left side-view mirror. The second sensor 220, like the second camera 120, may be disposed on the right side-view mirror or may be disposed adjacent to the right side-view mirror.

As shown in FIG. 6a, the first monitor 310 may be disposed on the lower portion of a left A-pillar of the driver within the vehicle and may display an image recorded by the first camera 110. The second monitor 320 may be disposed on the lower portion of a right A-pillar of the driver within the vehicle and may display an image recorded by the second camera 120. In this case, the driver feels like existing side-view mirrors are disposed because the first monitor 310 and the second monitor 320 are disposed on both sides of the driver. Therefore, the driver can feel minimal awkwardness.

As shown in FIG. 2, the camera 100 may further include a third camera 130. Here, the third camera 130 may be disposed on the rear of the vehicle and record the straight rear of the vehicle. Also, the sensor 200 may further include a third sensor 230. Here, the third sensor 230 may be disposed on the straight rear of the vehicle and may sense a distance between the vehicle and the object located on the straight rear of the vehicle. Also, images recorded by the first camera 110, the second camera 120, and the third camera 130 may be all displayed on one monitor 300.

In this case, as shown in FIG. 6b, the monitor 300 may be disposed in front of the driver and on the dashboard of the vehicle. Also, as shown in FIG. 6c, the monitor 300 may be disposed on the room mirror of the vehicle. Also, the monitor 300 may be built in the dashboard of the vehicle. As shown in FIG. 7a, the left side-rear image of the vehicle recorded by the first camera 110 may be displayed on a left area 301 of the monitor 300, and the right side-rear image of the vehicle recorded by the second camera 120 may be displayed on a right area 302 of the monitor 300. Also, as shown in FIG. 7b, the left side-rear image of the vehicle recorded by the first camera 110 may be displayed on the left area 301 of the monitor 300, and the right side-rear image of the vehicle recorded by the second camera 120 may be displayed on the right area 302 of the monitor 300, and the straight rear image of the vehicle recorded by the third camera 130 may be displayed on a middle area 303 of the monitor 300. In this case, the driver is able to check both the left side-rear image and the right side-rear image of the vehicle through one monitor 300 without turning his/her head.

Also, as shown in FIGS. 5d and 5e, the camera 10 may include a wide angle camera 140 which uses a wide angle lens such as a fisheye lens. Specifically, the wide angle camera 140 may be, as shown in FIG. 5d, disposed on the rear window of the vehicle 10 or may be, as shown in FIG. 5e, disposed on the top surface of the vehicle 10. When the wide angle camera 140 is, as shown in FIG. 5d, disposed on the rear window of the vehicle 10, the wide angle camera 140 may be disposed within the vehicle 10 and the rear of the vehicle 10 may be recorded in more detail. Also, when the wide angle camera 140 is, as shown in FIG. 5e, disposed on the top surface of the vehicle 10, the wide angle camera 140 may be disposed on a more forward portion of the vehicle, so that the side recording area of the vehicle becomes larger. As such, by recording the side-rear of the vehicle 10 by using the wide angle camera 140, it is possible to record a panoramic image including both the left side-rear area and the right side-rear area of the vehicle. Therefore, the image of the left side-rear area and the image of the right side-rear area are extracted from the image recorded by the wide angle camera 140, so that the image of the left side-rear area may be displayed on the first monitor 310 and the image of the right side-rear area may be displayed on the second monitor 320. Likewise, as shown in FIG. 7b, the extracted image of the left side-rear area may be displayed on the left area 301 of the monitor 300, the extracted image of the right side-rear area may be displayed on the right area 302, and the extracted image of the straight rear area may be displayed on the middle area 303.

Also, both the visual warning signal and the auditory warning signal may be output through the monitor 300. Otherwise, the visual warning signal may be output through the monitor 300 and the auditory warning signal may be output through a speaker (not shown), buzzer, etc., provided separately from the monitor 300. Also, the tactile warning signal may be output through a vibration device disposed on the steering, sheet, etc., of the vehicle 10.

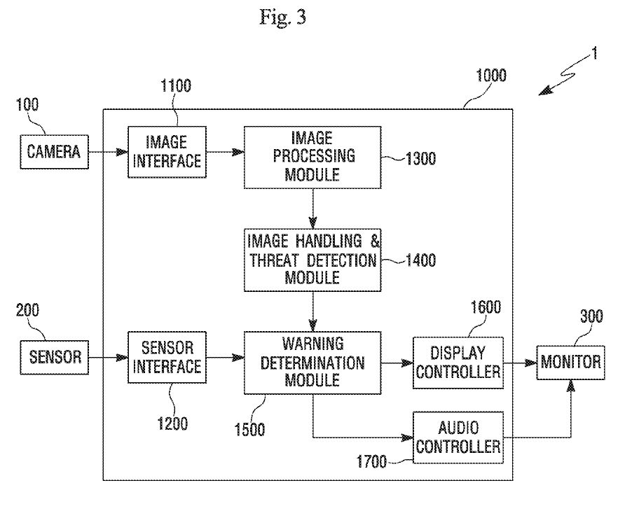

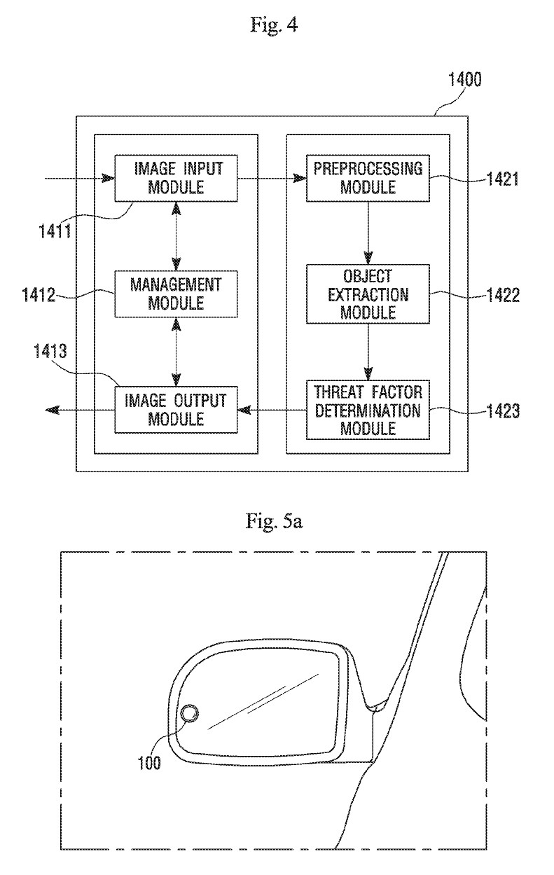

FIG. 3 is a view showing the vehicle side-rear warning device according to the embodiment of the present invention. FIG. 4 is a block diagram showing an image handling and threat detection module of the vehicle side-rear warning device according to the embodiment of the present invention.

As shown in FIG. 3, the side-rear warning system control unit 1000 included in the vehicle side-rear warning device 1 according to the embodiment of the present invention may include an image interface 1100, a sensor interface 1200, an image processing module 1300, an image handling and threat detection module 1400, an warning determination module 1500, a display controller 1600, and an audio controller 1700. The image signal recorded by the camera 100 may be input to the image interface 1100, and then the image signal which has passed through the image interface 1100 may be transmitted to the image processing module 1300. The image signal transmitted to the image processing module 1300 may be transmitted to the image handling and threat detection module 1400. The image signal which has been processed by the image handling and threat detection module 1400 and includes information on the threat detection may be transmitted to the warning determination module 1500. Also, the signal sensed by the sensor 200 is input to the sensor interface 1200, and the signal which has passed through the sensor interface 1200 may be transmitted to the warning determination module 1500. Here, if the warning determination module 1500 determines that the object exists on the side-rear of the vehicle, the warning determination module 1500 may generate a warning signal and may transmit the image signal including the visual warning signal to the display controller 1600 or may transmit the auditory warning signal to the audio controller 1700. Also, the auditory warning signal may be transmitted to a vibration device controller (not shown). If the warning determination module 1500 determines that the object does not exist on the side-rear of the vehicle, the warning determination module 1500 may transmit the image signal including no visual warning signal to the display controller 1600. Then, the image signal and/or the audio signal input to the display controller 1600 and/or the audio controller 1700 may be transmitted to the monitor 300.

Here, as shown in FIG. 4, the image handling and threat detection module 1400 of the vehicle side-rear warning device according to the embodiment of the present invention may include an image handling module 1410 and a threat detection module 1420. Specifically, the image handling module 1410 may include an image input module 1411, a management module 1412, and an image output module 1413. The threat detection module 1420 may include a preprocessing module 1421, an object extraction module 1422, and a threat factor determination module 1423. The image signal which is input to the image handling and threat detection module 1400 through the image processing module 1300 may be input to the image input module 1411 of the image handling module 1410. Then, the input image signal may be transmitted to the management module 1412 of the image handling module 1410 and to the preprocessing module 1421 of the threat detection module 1420. The management module 1412 of the image handling module 1410 manages the image handling module 1410. The management module 1412 may manage the image signal which is input to the image input module 1411 and the image signal which is output from the image output module 1413. The image signal input to the preprocessing module 1421 of the threat detection module 1420 may go through the pre-process and then be transmitted to the object extraction module 1422. The object extraction module 1422 may extract the object from the input image. Subsequently, a signal including information on the object may be transmitted to the threat factor determination module 1423. The threat factor determination module 1423 determines whether the input object is a threat factor or not in accordance with a predetermined criterion. Then, a signal including information on whether the object is a threat factor or not may be transmitted to the image output module 1413 of the image handling module 1410. The image output module 1413 of the image handling module 1410 may transmit the image signal and the signal including the information on the threat factor to the warning determination module 1500.

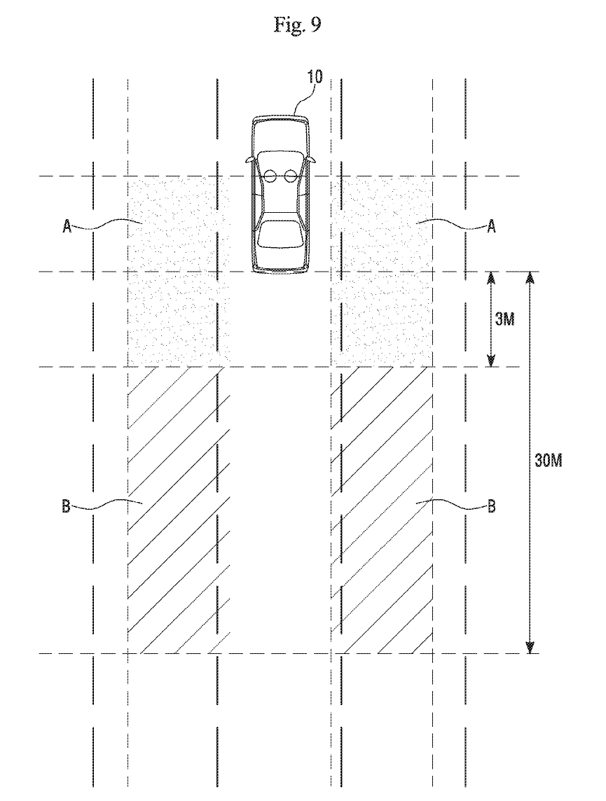

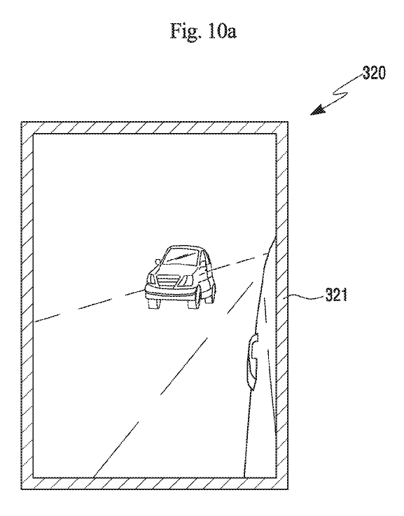

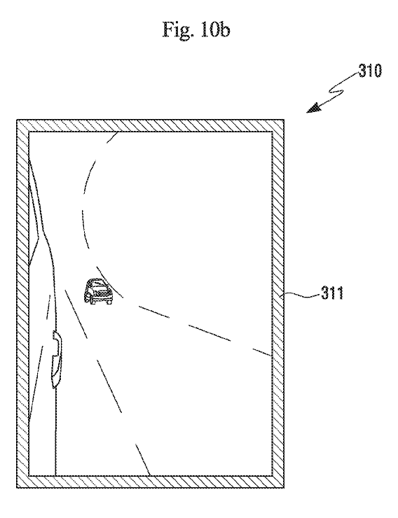

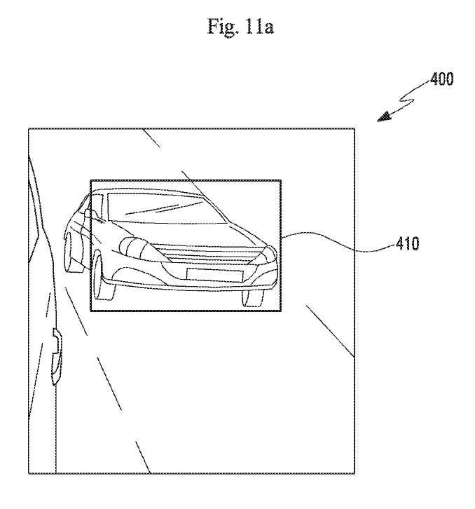

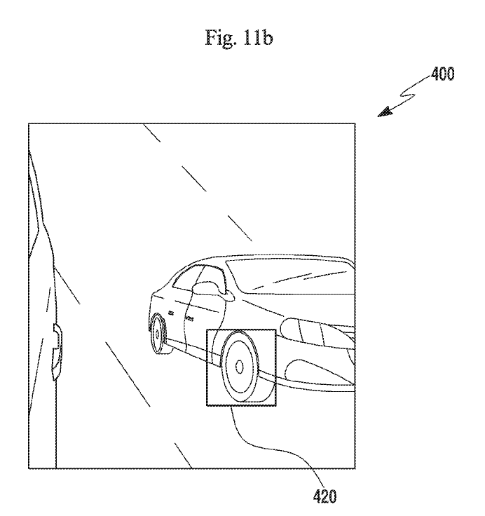

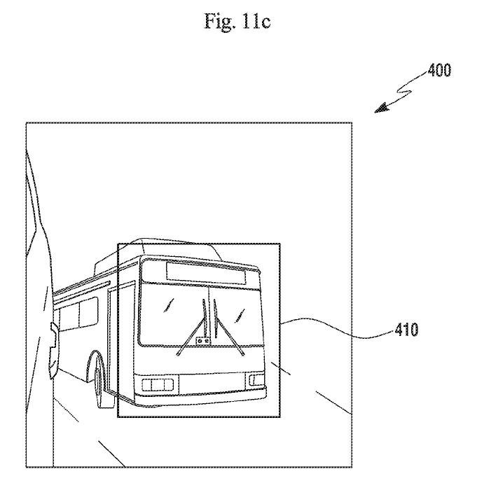

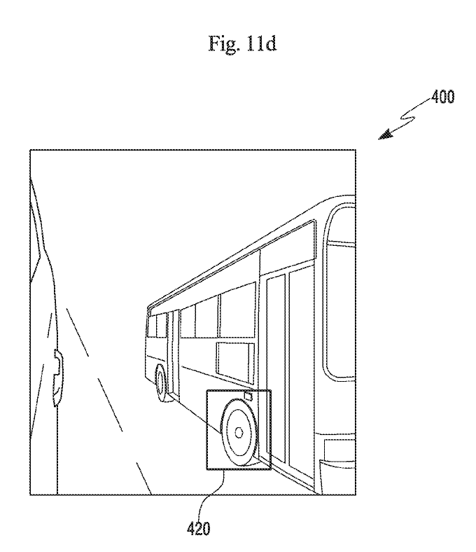

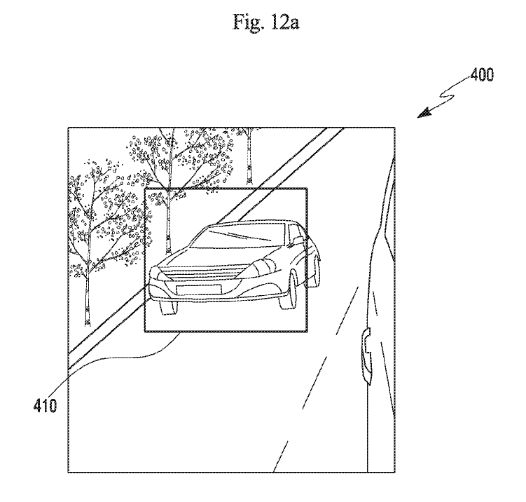

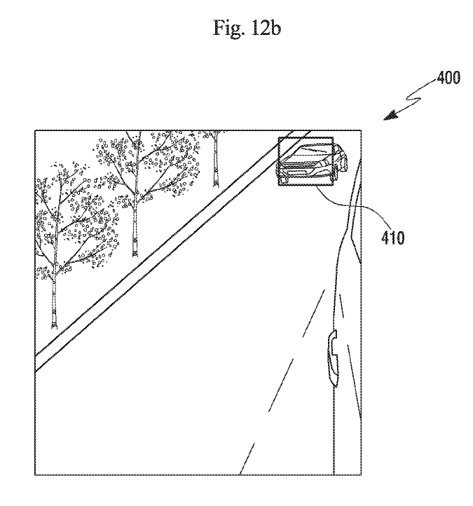

FIG. 9 is a view for describing that the threat detection module according to the embodiment of the present invention determines whether the object included in the image is a threat factor or not. FIGS. 10a and 10b are views showing that the warning signal and the image are displayed on the monitor according to the embodiment of the present invention. FIGS. 11a to 11d are views for describing a method for detecting the object included in the image recorded by the camera according to the embodiment of the present invention. FIGS. 12a and 12b are views for describing whether the object in the image recorded by the camera according to the embodiment of the present invention is a threat factor or not in accordance with the size of a detection target.

As shown in FIG. 9, when the object included in the image is located at a predetermined area, the threat detection module 1420 may determine that the object is a threat factor. Specifically, the threat detection module 1420 determines whether the object is a threat factor or not by determining whether or not the object is parallel with the front edge of the vehicle 10 and is located within a first area “B” that is 3 M to 30 M away from the rear of the vehicle 10, or it is determined whether or not the object is parallel with the front edge of the vehicle 10 and is located within a second area “A” that is from a position located at the center of the sight range of 95% and is within 3 M from the rear of the vehicle 10. Then, the warning determination module 1500 may determine whether or not the object exists on the side-rear of the vehicle, on the basis of the image signal output from the image handling and threat detection module 1400, the signal including the information on the threat factor, and the sensed signal output from the sensor interface 1200. Specifically, when the warning determination module 1500 determines that the object is located within the first area “B” on the basis of the signal including the information on the threat factor, which has been received from the image handling and threat detection module 1400, and when the warning determination module 1500 determines that the object is located within the first area “B” on the basis of the sensed signal, the warning determination module 1500 determines that the threat level of the object is a first threat level. When the warning determination module 1500 determines that the object is located farther than the first area “B” on the basis of at least one of the two signals, the warning determination module 1500 does not determine that the threat level of the object is the first threat level. Also, when the warning determination module 1500 determines that the object is located within the second area “A” on the basis of the signal including the information on the threat factor, which has been received from the image handling and threat detection module 1400, and when the warning determination module 1500 determines that the object is located within the second area “A” on the basis of the sensed signal, the warning determination module 1500 determines that the threat level of the object is a second threat level. When the warning determination module 1500 determines that the object is located farther than the second area “A” on the basis of at least one of the two signals, the warning determination module 1500 does not determine that the threat level of the object is the second threat level. As such, only when the warning determination module 1500 determines that the threat factor corresponds to the threat level by using both the two signals, that is, the image signal and the sensing signal, the warning determination module 1500 determines that the threat factor exists. Therefore, whether the threat factor exists or not can be more accurately determined.

As described above, when the warning determination module 1500 determines whether or not the object exists on the side-rear of the vehicle and, as a result, determines that the object exists on the side-rear of the vehicle, the visual warning signal and the recorded image may be displayed on the monitor 300. Specifically, when the warning determination module 1500 determines that a vehicle approaching to the right side of the vehicle is located at the second area “A” shown in FIG. 9, in other words, when the warning determination module 1500 determines that the threat level of the approaching vehicle is the second threat level, a second visual warning signal may be, as shown in FIG. 10a, displayed on a warning area 321 included in the edge of the second monitor 320. Likewise, when the warning determination module 1500 determines that a vehicle approaching to the left side of the vehicle is located at the first area “B” shown in FIG. 9, in other words, when the warning determination module 1500 determines that the threat level of the approaching vehicle is the first threat level, a first visual warning signal may be, as shown in FIG. 10b, displayed on a warning area 311 included in the edge of the first monitor 310. Here, the first visual warning signal corresponding to the first threat level may be different from the second visual warning signal corresponding to the second threat level. Specifically, when it is determined that there is no threat factor, the warning areas 311 and 321 may be represented with by a green color. When it is determined that the threat level of the object is the first threat level, the warning areas 311 and 321 may be represented with by an orange color. When it is determined that the threat level of the object is the second threat level, the warning areas 311 and 321 may be represented with by a red color. Also, when the second visual warning signal is brighter than the first visual warning signal or when the visual warning signal is repeated with a period, the period of the second visual warning signal may be less than the period of the first visual warning signal. Likewise, a first auditory warning signal corresponding to the first threat level may be different from a second auditory warning signal corresponding to the second threat level. Specifically, when the volume of the second auditory warning signal is greater than the volume of the first auditory warning signal or when the auditory warning signal is repeated with a period, the period of the second auditory warning signal may be less than the period of the first auditory warning signal. Likewise, a first tactile warning signal corresponding to the first threat level may be different from a second tactile warning signal corresponding to the second threat level. Specifically, when the magnitude of vibration of the second tactile warning signal is greater than the magnitude of the vibration of the first tactile warning signal or when the tactile warning signal is repeated with a period, the period of the second tactile warning signal may be less than the period of the first tactile warning signal.

Here, the image signal recorded without the visual warning signal may be displayed on the monitor 300 during normal driving, and the visual warning signal may be output only when the turn signal lamp of the vehicle is turned on. Similarly, the auditory warning signal and/or the tactile warning signal may not be output during normal driving, and may be output only when the turn signal lamp of the vehicle is turned on. When, as described above, the warning signal is output only when the turn signal lamp of the vehicle is turned on, the warning signal can be output only when there is a requirement for the information on whether the object exists on the side-rear of the vehicle or not, for example, a lane change, etc. Also, when there is no requirement for the information on whether the object exists on the side-rear of the vehicle or not, the warning signal is not output.

Also, the warning signal may be output only when the speed of the vehicle 10 is equal to or greater than a predetermined speed, and the warning signal may not be output when the speed of the vehicle 10 is less than the predetermined speed. The speed information of the vehicle 10 is used to determine whether the vehicle 10 is traveling or not. The speed information may be obtained from the vehicle 10 or may be obtained from other sensors such as an acceleration sensor within the system. Such a predetermined speed may be set by the driver.

Hereinafter, a detailed method in which the threat detection module 1420 determines whether the object is the threat factor or not will be described.

As shown in FIGS. 11a to 11d, the threat detection module 1420 may extract the object from an image 400 and may extract a detection target 410 from the object. Here, the threat detection module 1420 first may designate an interest area in the image 400 and then may extract the object. The interest area may be an area excluding the area where the object cannot be located in the image 400. The area where the object cannot be located may be an area corresponding to the sky, an area corresponding to the vehicle 10, etc. When the object is extracted after the interest area is designated in the image 400, it is possible to reduce a computing time period required for extracting the object because data can be analyzed and processed only for the area where the object can be located. The detection target 410 may be, as shown in FIGS. 11a or 11c, the front side of the object. Also, the detection target 410 may be, as shown in FIGS. 11b or 11d, the wheel of the object. Here, the vehicle side-rear warning device according to the embodiment of the present invention may include a memory (not shown) that stores the size and/or shape of the portion corresponding to the various detection targets 410 of the vehicle. Specifically, in an image obtained by the camera 100 of the present invention that has recorded a vehicle of a specific model approaching the vehicle 10, the memory may store the size and/or shape of the detection target 410 corresponding to the front side or wheel of the vehicle of a specific model. Here, the size of the detection target 410 may be stored as the size of the pixels that the area of the detection target 410 occupies in the image 400. Also, such a size of the detection target 410 may be also classified according to the type of a vehicle approaching the vehicle 10 and stored. Specifically, the approaching vehicle is divided into three types of a truck, a bus, and a sedan, and then the size of the detection target 410 corresponding to each of the vehicle types may be stored. Here, the size of the detection target 410 may be stored to correspond to the first area “B” and the second area “A”. Specifically, for example, as shown in FIG. 12a, the size of the detection target 410 of a sedan, which corresponds to the second area “A”, may be equal to or larger than 160×160. As shown in FIG. 12b, the size of the detection target 410 of the sedan, which corresponds to the first area “B”, may be from 40×40 to 160×160.

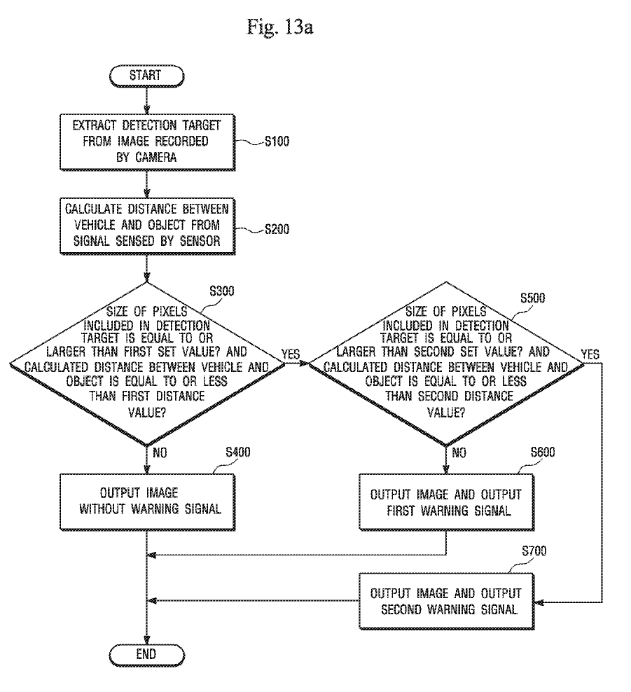

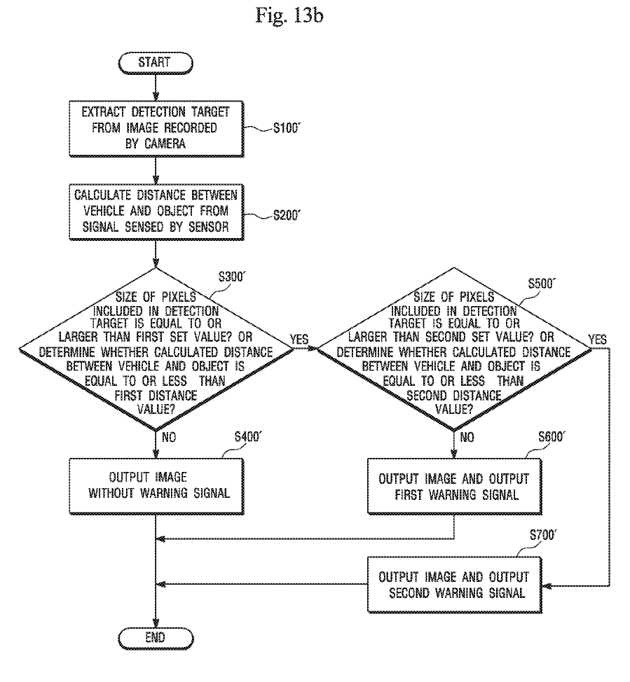

FIGS. 13a and 13b are flowcharts for describing a warning method of the vehicle side-rear warning device according to the embodiment of the present invention.

As shown in FIG. 13a, the detection target 410 of the object is extracted from the side-rear image 400 of the vehicle recorded by the camera 100 disposed on the vehicle (S100). A distance between the vehicle 10 and the object is calculated from the signal sensed by the sensor 200 disposed on the vehicle (S200).

It is determined that the threat level of the object is the first threat level when the size of pixels of the object included in the detection target 410 is equal to or larger than a first set value and the calculated distance between the vehicle and the object is equal to or less than a first distance value (S300). Specifically, it is determined whether or not the size of the pixels included in the detection target 410 is equal to or larger than 40×40, i.e., the size of the pixels of the detection target 410, which corresponds to the first area “B” that is within 30 M from the rear of the vehicle 10, and it is determined whether the distance between the vehicle 10 and the object calculated from the signal sensed by the sensor 200 is within 30 M or not.

If at least any one of the two conditions is not satisfied, the warning signal is not output and the recorded image 400 is output through the monitor 300 (S400).

If the two conditions are all satisfied, it is determined that the threat level of the object is the first threat level. And then it is determined that the threat level of the object is the second threat level when the size of pixels included in the detection target 410 is equal to or larger than a second set value and the calculated distance between the vehicle and the object is equal to or less than a second distance value (S500). Here, the first set value may be less than the second set value, and the first distance value may be larger than the second distance value. Specifically, it is determined whether or not the size of the pixels included in the detection target 410 is equal to or larger than 160×160, i.e., the size of the pixels of the detection target 410, which corresponds to the second area “A” that is parallel with the front edge of the vehicle 10 and is from a position located at the center of the sight range of 95% and is within 3 M from the rear of the vehicle 10, and it is determined whether the distance between the vehicle 10 and the object calculated from the signal sensed by the sensor 200 is within 3 M or not.

If at least one of the two conditions is not satisfied, it is determined that the object exists in the first area “B”, the first warning signal is output, and the recorded image 400 is output through the monitor 300 (S600).

If the two conditions are all satisfied, it is determined whether the object exists in the second area “A”, the second warning signal is output, and the recorded image 400 is output through the monitor 300 (S700).

As shown in FIG. 13b, the detection target 410 of the object is extracted from the side-rear image 400 of the vehicle recorded by the camera 100 disposed on the vehicle (S100′). A distance between the vehicle 10 and the object is calculated from the signal sensed by the sensor 200 disposed on the vehicle (S200′).

It is determined that the threat level of the object is the first threat level when the size of pixels of the object included in the detection target 410 is equal to or larger than a first set value or the calculated distance between the vehicle and the object is equal to or less than a first distance value (S300′). Specifically, it is determined whether or not the size of the pixels included in the detection target 410 is equal to or larger than 40×40, i.e., the size of the pixels of the detection target 410, which corresponds to the first area “B” that is within 30 M from the rear of the vehicle 10, or it is determined whether the distance between the vehicle 10 and the object calculated from the signal sensed by the sensor 200 is within 30 M or not.

If neither of the two conditions are satisfied, the warning signal is not output and the recorded image 400 is output through the monitor 300 (S400′).

If at least any one of the two conditions is satisfied, it is determined that the threat level of the object is the first threat level. And then it is determined that the threat level of the object is the second threat level when the size of pixels included in the detection target 410 is equal to or larger than a second set value or the calculated distance between the vehicle and the object is equal to or less than a second distance value (S500′). Here, the first set value may be less than the second set value, and the first distance value may be larger than the second distance value. Specifically, it is determined whether or not the size of the pixels included in the detection target 410 is equal to or larger than 160×160, i.e., the size of the pixels of the detection target 410, which corresponds to the second area “A” that is parallel with the front edge of the vehicle 10 and is from a position located at the center of the sight range of 95% and is within 3 M from the rear of the vehicle 10, or it is determined whether the distance between the vehicle 10 and the object calculated from the signal sensed by the sensor 200 is within 3 M or not.

If neither of the two conditions are satisfied, it is determined that the object exists in the first area “B”, the first warning signal is output, and the recorded image 400 is output through the monitor 300 (S600′).

If at least any one of the two conditions is satisfied, it is determined whether the object exists in the second area “A”, the second warning signal is output, and the recorded image 400 is output through the monitor 300 (S700′).

Here, the first warning signal may include at least any one of the first visual warning signal, the first auditory warning signal, and the first tactile warning signal. The second warning signal may include at least any one of the second visual warning signal, the second auditory warning signal, and the second tactile warning signal.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A vehicle side-rear warning device comprising:
a camera which records a side-rear of a vehicle;
a sensor;
a monitor which displays an image recorded by the camera; and
a side-rear warning system control unit,
wherein an image signal recorded by the camera and a signal sensed by the sensor are input to the side-rear warning system control unit,
wherein the side-rear warning system control unit determines whether an object is located at a predetermined area of the side-rear of the vehicle or not on the basis of the input image signal and the input signal sensed by the sensor,
wherein, when it is determined that the object is located at a predetermined area of the side-rear of the vehicle, the side-rear warning system control unit outputs a warning signal, and when it is determined that the object is not located at a predetermined area of the side-rear of the vehicle, the side-rear warning system control unit does not output the warning signal,
and wherein the monitor displays the image signal received from the side-rear warning system control unit.

2. The vehicle side-rear warning device of claim 1, wherein the side-rear warning system control unit determines that the object is located at a predetermined area of the side-rear of the vehicle when a condition that an area of the object included in the image recorded by the camera is equal to or larger than a first set value and a condition that a distance between the vehicle and the object calculated from the sensed signal is equal to or less than a first distance value are all satisfied.

3. The vehicle side-rear warning device of claim 2, wherein the condition that a size of the object is equal to or larger than the first set value corresponds to a condition that a size of pixels included in an area that a front side or a wheel of the object occupies is equal to or larger than the first set value.

4. The vehicle side-rear warning device of claim 1, wherein the side-rear warning system control unit determines that the object is located at a predetermined area of the side-rear of the vehicle when at least one of a condition that a size of the object included in the image recorded by the camera is equal to or larger than a first set value and a condition that a distance between the vehicle and the object calculated from the sensed signal is equal to or less than a first distance value is satisfied.

5. The vehicle side-rear warning device of claim 4, wherein the condition that a size of the object is equal to or larger than the first set value corresponds to a condition that a size of pixels included in an area that a front side or a wheel of the object occupies is equal to or larger than the first set value.

6. The vehicle side-rear warning device of claim 1,
wherein the camera comprises a first camera and a second camera,
wherein the first camera records a left side-rear of the vehicle,
wherein second camera records a right side-rear of the vehicle,
wherein the first camera is disposed on a left side-view mirror of the vehicle,
and wherein the second camera is disposed on a right side-view mirror of the vehicle.

7. The vehicle side-rear warning device of claim 6,
wherein the monitor comprises a first monitor and a second monitor,
wherein the first monitor displays an image recorded by the first camera,
wherein the second monitor displays an image recorded by the second camera,
wherein the first monitor is disposed on a lower portion of a left A-pillar within the vehicle,
and wherein the second monitor is disposed on a lower portion of a right A-pillar within the vehicle.

8. The vehicle side-rear warning device of claim 6,
wherein an image recorded by the first camera is displayed on a left area of the monitor,
wherein an image recorded by the second camera is displayed on a right area of the monitor,
and wherein the monitor is disposed on a dashboard of the vehicle, is built in the dashboard of the vehicle, or is disposed on a room mirror of the vehicle.

9. The vehicle side-rear warning device of claim 6,
wherein the camera further comprises a third camera which records the rear of the vehicle,
wherein the image recorded by the first camera is displayed on a left area of the monitor,
wherein the image recorded by the second camera is displayed on a right area of the monitor,
and wherein the image recorded by the third camera is displayed on a middle area of the monitor.

10. The vehicle side-rear warning device of claim 1,
wherein the camera comprises a wide angle camera,
wherein the wide angle camera records a left side-rear area of the vehicle and a right side-rear area of the vehicle,
and wherein the wide angle camera is disposed on a rear window of the vehicle or is disposed on a top surface of the vehicle.

11. The vehicle side-rear warning device of claim 10,
wherein the monitor comprises a first monitor and a second monitor,
wherein the first monitor displays the image of the left side-rear area of the vehicle extracted from the image recorded by the wide angle camera,
wherein the second monitor displays the image of the right side-rear area of the vehicle extracted from the image recorded by the wide angle camera,
wherein the first monitor is disposed on a lower portion of a left A-pillar within the vehicle,
and wherein the second monitor is disposed on a lower portion of a right A-pillar within the vehicle.

12. The vehicle side-rear warning device of claim 10,
wherein the image of the left side-rear area of the vehicle extracted from the image recorded by the wide angle camera is displayed on a left area of the monitor,
wherein the image of the right side-rear area of the vehicle extracted from the image recorded by the wide angle camera is displayed on a right area of the monitor,
and wherein the monitor is disposed on a dashboard of the vehicle, is built in the dashboard of the vehicle, or is disposed on a room mirror of the vehicle.

13. The vehicle side-rear warning device of claim 10,
wherein the image of the left side-rear area of the vehicle extracted from the image recorded by the wide angle camera is displayed on a left area of the monitor,
wherein the image of the right side-rear area of the vehicle extracted from the image recorded by the wide angle camera is displayed on a right area of the monitor,
wherein an image of a straight rear image of the vehicle extracted from the image recorded by the wide angle camera is displayed on a middle area of the monitor,
and wherein the monitor is disposed on a dashboard of the vehicle, is built in the dashboard of the vehicle, or is disposed on a room mirror of the vehicle.

14. The vehicle side-rear warning device of claim 1, wherein the warning signal is output when a turn signal lamp of the vehicle is turned on and the warning signal is not output when the turn signal lamp of the vehicle is turned off.

15. The vehicle side-rear warning device of claim 1, wherein the warning signal is output when a speed of the vehicle is equal to or greater than a predetermined speed and the warning signal is not output when the speed of the vehicle is less than the predetermined speed.

16. A warning method of a side-rear warning device of a vehicle, the warning method comprising:
extracting a detection target of an object from a side-rear image of the vehicle recorded by a camera disposed on the vehicle;
calculating a distance between the vehicle and the object from a signal sensed by a sensor disposed on the vehicle;
determining that a threat level of the object is a first threat level when the size of pixels included in the detection target is equal to or larger than a first set value and the calculated distance is equal to or less than a first distance value;
displaying, when it is not determined that the threat level of the object is the first threat level, the recorded image on a monitor disposed in the vehicle without outputting a warning signal;
determining that the threat level of the object is a second threat level when it is determined that the threat level of the object is the first threat level and when the size of pixels included in the detection target is equal to or larger than a second set value larger than the first set value and the calculated distance is equal to or less than a second distance value less than the first distance value;
displaying the recorded image on the monitor and outputting a first warning signal, when it is not determined that the threat level of the object is the second threat level; and
displaying the recorded image on the monitor and outputting a second warning signal, when it is determined that the threat level of the object is the second threat level.

17. The warning method of claim 16,
wherein the first warning signal comprises at least any one of a first visual warning signal, a first auditory warning signal, and a first tactile warning signal,
and wherein the second warning signal comprises at least any one of a second visual warning signal, a second auditory warning signal, and a second tactile warning signal.

18. A warning method of a side-rear warning device of a vehicle, the warning method comprising:
extracting a detection target of an object from a side-rear image of the vehicle recorded by a camera disposed on the vehicle;
calculating a distance between the vehicle and the object from a signal sensed by a sensor disposed on the vehicle;
determining that a threat level of the object is a first threat level when the size of pixels included in the detection target is equal to or larger than a first set value or the calculated distance is equal to or less than a first distance value;
displaying, when it is not determined that the threat level of the object is the first threat level, the recorded image on a monitor disposed in the vehicle without outputting a warning signal;
determining that the threat level of the object is a second threat level when it is determined that the threat level of the object is the first threat level and when the size of pixels included in the detection target is equal to or larger than a second set value larger than the first set value or the calculated distance is equal to or less than a second distance value less than the first distance value;
displaying the recorded image on the monitor and outputting a first warning signal, when it is not determined that the threat level of the object is the second threat level; and
displaying the recorded image on the monitor and outputting a second warning signal, when it is determined that the threat level of the object is the second threat level.

19. The warning method of claim 18,
wherein the first warning signal comprises at least any one of a first visual warning signal, a first auditory warning signal, and a first tactile warning signal,
and wherein the second warning signal comprises at least any one of a second visual warning signal, a second auditory warning signal, and a second tactile warning signal.
